(19) United States
(12) Patent Application Publication
(10) Pub. No.: US 2009/0052849 A1
(43) Pub. Date: Feb. 26, 2009

(54) OPTICAL FIBER PROBE FOR SIDE IMAGING AND METHOD OF MANUFACTURING THE SAME

(75) Inventors: Byeong Ha LEE, Gwangju (KR); Hae Young Choi, Gwangju (KR); Seon Young Ryu, Gwangju (KR); Jihoon Na, Gwangju (KR); Ik-Bu Sohn, Gwangju (KR); Young-Chul Noh, Gwangju (KR); Jongmin Lee, Gwangju (KR)

Correspondence Address: AMPACC LAW GROUP, 13024 Beverly Park Road, Suite 205, Mukilteo, WA, 98275, US

(73) Assignee: Gwangju Institute of Science and Technology, Gwangju (KR)

(21) Appl. No.: 12/182,015

(22) Filed: Jul. 29, 2008

(30) Foreign Application Priority Data
Aug. 22, 2007 (KR) 10-2007-0084404

(51) Int. Cl. G02B 6/06

(52) U.S. Cl. 385/119

(57) ABSTRACT

Disclosed are an optical fiber probe for side imaging and a method of manufacturing the same. An optical fiber probe according to an aspect of the invention includes a photonic crystal fiber, and an optical fiber lens that is formed by applying heat to a predetermined region including one end of the photonic crystal fiber and substantially removing air holes formed in the predetermined region. The optical fiber lens includes a light diffusion region that diffuses light propagating along a core of the photonic crystal fiber and focuses the light to enable side imaging, a reflector surface that reflects the light at a right angle to enable side imaging, and a lens surface that focuses the light. A small-sized optical fiber probe can be manufactured using a simple manufacturing process, and the optical fiber probe can be miniaturized. Therefore, a light measurement system can be miniaturized, which makes it possible to obtain side images of a very small sample, such as a blood vessel.

### BACKGROUND OF THE INVENTION

1. Technical Field

The present invention relates to an optical fiber probe and a method of manufacturing the same, and more particularly, to an optical fiber probe for side imaging and a method of manufacturing the same.

2. Related Art

An optical fiber lens has been used in a field of optical communication to improve optical coupling efficiency at the time of optical coupling between a light source or an optical element and an optical fiber or optical coupling between two optical fibers with a predetermined distance, and manufacture a small-sized module.

In recent years, the optical fiber lens has been widely used for an imaging system using light or a medical treatment apparatus using a laser as well as the field of optical communication.

In particular, an optical fiber probe has been used to miniaturize an imaging system using light.

An optical fiber probe-based tomographic imaging system using light requires a light source having a wide bandwidth and an optical fiber probe operating in a single mode in a wide wavelength band in order to achieve high resolution.

In order to miniaturize an optical imaging system and obtain side images of a sample, such as a blood vessel, having a very small size, an optical fiber probe for side imaging is being used.

In the related art, in order to manufacture an optical fiber probe for side imaging to have a small size, various methods have been used. Among the methods, the following three methods are mainly used.

According to a first method, a bulk-typed element, such as a microprism or a reflection mirror, is installed at one end of an optical fiber. In the first method, as compared with the case where an optical fiber probe is manufactured only using an optical fiber, it is possible to use lenses having relatively large apertures and various types or functions. Therefore, it is possible to provide a superior optical coupling characteristic. However, since a small-sized optical fiber needs to be coupled to a bulk element, such as a microprism or a reflection mirror, having a relatively large volume, a manufacturing process is complicated, and the size of the manufactured optical fiber probe is increased.

According to a second method, an element, such as a cylindrical graded index (GRIN) lens or a commercially used ball lens, is bonded to one end of a single mode (SM) optical fiber, and the GRIN lens or the ball lens is cut or polished at a predetermined angle. The second method is advantageous in that an optical fiber probe can be formed to have a small size, and a relatively long working distance can be obtained. However, in order to obtain a long working distance to search a sample up to a predetermined depth, an elaborated process is required in which a GRIN lens having a relatively accurate length is bonded to a single mode optical fiber.

According to a third method, a GRIN lens and a micro beam splitter are sequentially bonded to one end of a single mode optical fiber. In the third embodiment, the total size of an optical fiber probe is small and a working distance is sufficiently long. However, since an elaborated bonding process between the single mode optical fiber and the GRIN lens and between the GRIN lens and the micro beam splitter is required, a manufacturing process is very complicated.

### SUMMARY OF THE INVENTION

Accordingly, it is a first object of the invention to provide an optical fiber probe for side imaging that can be manufactured to have a small size using a relatively simple manufacturing process.

Further, it is a second object of the invention to provide a method of manufacturing the optical fiber probe for side imaging.

In order to achieve the above-described objects of the invention, according to an aspect of the invention, an optical fiber probe includes a photonic crystal fiber; and an optical fiber lens that is formed by applying heat to a predetermined region including one end of the photonic crystal fiber and substantially removing air holes formed in the predetermined region, and diffuses light propagating along a core of the photonic crystal fiber and focuses the light to enable side imaging. The optical fiber lens may include a light diffusion region that is formed by applying the heat to the predetermined region including one end of the photonic crystal fiber and substantially removing the air holes formed in the predetermined region; a reflector surface that is formed by, at a predetermined angle, cutting a first region of a ball lens formed at one end of the photonic crystal fiber together with the light diffusion region during the heat application process so as to enable full reflection; and a lens surface that is formed in a second region of the ball lens and focuses the light reflected on the reflector surface. Heat may be applied to the predetermined region including one end of the photonic crystal fiber using one of arc discharge, a CO₂ laser, and an oxygen-hydrogen flame. The reflector surface may be formed by cutting the first region of the ball lens using one of mechanical cutting, polishing, chemical etching, and laser processing. The laser processing may be performed using a femtosecond laser. The reflector surface may be subjected to a highly reflective coating process so as to improve reflection efficiency.

According to another aspect of the invention, an optical fiber probe includes a first optical fiber including a core; and an optical fiber lens that is formed by performing heterojunction between one end of a second optical fiber and one end of the first optical fiber and applying heat to the other end of the second optical fiber to form a ball lens, and diffuses light propagating along a core of the first optical fiber to have a predetermined amount of light and focuses the light to enable side imaging. The optical fiber lens may include a light diffusion region that diffuses the light propagating along the core of the first optical fiber; a reflector surface that is formed by cutting, at a predetermined angle, the first region of the ball lens formed by applying heat to the other end of the second optical fiber so as to enable full reflection; and a lens surface that is formed in a second region of the ball lens and focuses light reflected on the reflector surface.

According to still another aspect of the invention, there is provided a method of manufacturing an optical fiber probe. The method includes providing a photonic crystal fiber; applying heat to a predetermined region including one end of the photonic crystal fiber and substantially removing air holes formed in the predetermined region; continuously applying heat to the predetermined region to form a ball lens having a predetermined size; and forming a reflector surface and a lens surface functioning as a lens by cutting a first region of the ball lens at a predetermined angle to enable full reflection. The lens surface may be formed in a second region of the ball lens and focuses light reflected on the reflector surface. The applying of heat to the predetermined region including one end of the photonic crystal fiber may be applying heat to the predetermined region including one end of the photonic crystal fiber using one of arc discharge, a CO₂ laser, and an oxygen-hydrogen flame. The forming of the reflector surface by cutting the first region of the ball lens at the predetermined angle may be forming the reflector surface by cutting the first region of the ball lens at the predetermined angle using one of mechanical cutting, polishing, chemical etching, and laser processing. The laser processing may be performed using a femtosecond laser.

According to a further aspect of the invention, there is provided a method of manufacturing an optical fiber probe. The method includes providing a first optical fiber including a core; performing heterojunction between one end of a second optical fiber and one end of the first optical fiber and applying heat to a predetermined region including the other end of the second optical fiber so as to form a ball lens; and forming a reflector surface and a lens surface functioning as a lens by cutting a first region of the ball lens at a predetermined angle to enable full reflection. The second optical fiber may be a coreless optical fiber or a graded index (GRIN) lens.

A lens-typed optical fiber probe for side imaging can be manufactured to have a small size, and may be applied to a light measurement system that obtains two-dimensional and three-dimensional images for a sample, and an imaging system using light, such as an optical imaging system. Further, the lens-typed optical fiber probe may be applied to a laser processing system using a laser, and a medical treatment system using a laser, such as a laser needle.

As described above, according to the aspects of the invention, a lens-typed optical fiber probe for side imaging can be manufactured to have a small size, using a simple manufacturing process instead of a complicated manufacturing process as a disadvantage in a heterojunction-lens-typed optical fiber probe according to the related art.

Further, since the optical fiber probe can be miniaturized, a light measurement system can be miniaturized, and side images of a small sample, such as a blood vessel, can be obtained.

Furthermore, during a process of manufacturing a lens-typed optical fiber, an optical fiber does not need to be cut or fusion-spliced. Therefore, it is possible to maintain the strength of the optical fiber.

### BRIEF DESCRIPTION OF THE DRAWINGS

FIG. 1 is a cross-sectional view illustrating a lens-typed optical fiber probe for side imaging according to an embodiment of the invention;

FIG. 2 is a cross-sectional view illustrating a photonic crystal fiber shown in FIG. 1;

FIG. 3A is a cross-sectional view illustrating a photonic crystal fiber;

FIG. 3B is a cross-sectional view illustrating a lens-typed photonic crystal fiber that has a light diffusion region and a ball lens integrally formed at one end of a photonic crystal fiber;

FIG. 3C is a cross-sectional view illustrating an optical fiber probe based on a photonic crystal fiber that is formed by cutting a ball-lens-typed photonic crystal fiber shown in FIG. 3B at a predetermined angle to enable side imaging;

FIG. 3D is a diagram illustrating a photomicrographic image for a lens-typed optical fiber probe for side imaging that is manufactured using a femtosecond laser in accordance with the preferred embodiment of the invention;

FIG. 4 is a cross-sectional view illustrating an optical fiber probe for side imaging according to another embodiment of the invention;

FIG. 5A is a diagram illustrating an optical fiber probe package that is formed by packaging an optical fiber probe manufactured in accordance with an embodiment of the invention so as to be used for an optical imaging system;

FIG. 5B is a diagram illustrating an optical fiber probe package that is formed by packaging an optical fiber probe manufactured in accordance with another embodiment of the invention so as to be used for an optical imaging system;

FIG. 6A is a graph illustrating a measured result of a change in light power according to an offset distance between a lens surface and a reflecting mirror of an optical fiber probe according to an embodiment of the invention;

FIG. 6B is a graph illustrating a measured result of sizes of beams that are focused at a focal location of a lens of a lens-typed optical fiber probe according to an embodiment of the invention;

FIG. 7 is a conceptual diagram illustrating a light measurement system that is used to obtain side image information for a sample using an optical fiber probe for side imaging based on a lens-typed photonic crystal fiber according to an embodiment of the invention; and

FIG. 8 is a diagram illustrating a two-dimensional optical tomographic image for eyes of a Zebra fish that is a kind of tropical fish that is actually measured using an optical fiber probe for side imaging based on a photonic crystal fiber according to an embodiment of the invention in an optical tomographic imaging system.

### DESCRIPTION OF EXEMPLARY EMBODIMENT

The invention may be embodied in many different forms and have various embodiments. The invention will now be described more fully with reference to the accompanying drawings, in which preferred embodiments of the invention are shown. However, the invention should not be construed as being limited to the embodiments set forth herein, and it should be understood that all changes, modifications, and equivalents that fall within a technical sprit and scope of the invention are therefore intended to be embraced by the invention. Like reference numerals refer to like elements throughout the specification.

It will be understood that, although the terms first, second, etc. may be used herein to describe various components, the components should not be limited by these terms. These terms are only used to distinguish one component from another component. For example, a first component could be termed a second component, and the second component could be named the first component without departing from the scope of the invention. As used herein, the term “and/or” includes any and all combinations of one or more of the associated listed items.

It will be understood that when a component is referred to as being “connected to” or “coupled to” another component, it can be connected or coupled to the other component with intervening components therebetween. In contrast, when a component is referred to as being “directly connected to” or “directly coupled to” another component, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated characteristics, figures, steps, operations, components, or a combination thereof, but do not preclude the presence or addition of one or more other characteristics, figures, steps, operations, components or a combination thereof.

In addition, when terms used in this specification are not specifically defined, all the terms used in this specification (including technical and scientific terms) can be understood by those skilled in the art. Further, when general terms defined in the dictionaries are not specifically defined, the terms will have the normal meaning in the art.

Hereinafter, the preferred embodiments of the invention will be described in detail with reference to the accompanying drawings. In describing the invention, for better understanding of the invention, the same elements are denoted by the same reference numerals in the drawings.

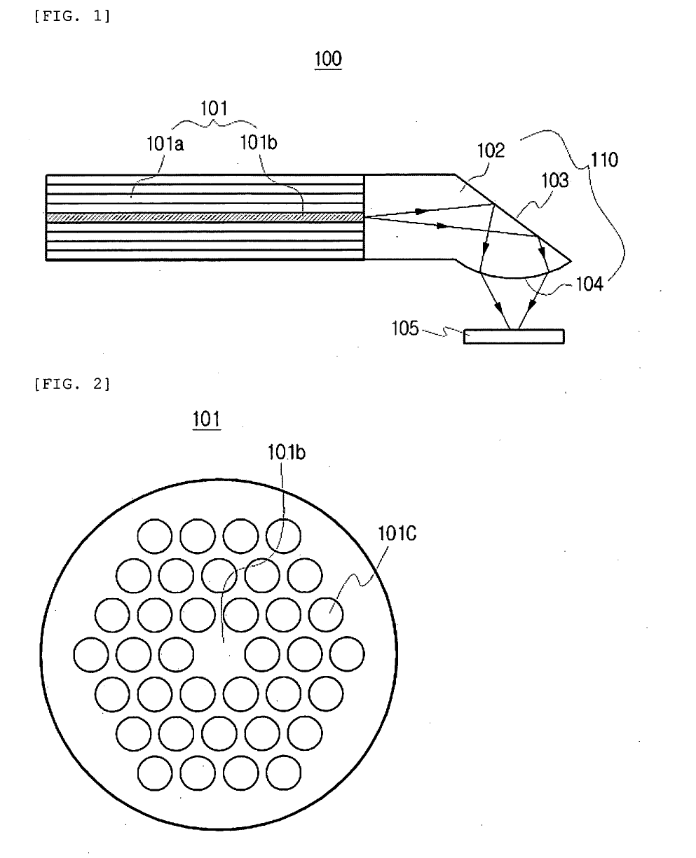

FIG. 1 is a cross-sectional view illustrating a lens-typed optical fiber probe for side imaging according to an embodiment of the invention.

Referring to FIG. 1, an optical fiber probe 100 includes a photonic crystal fiber 101 and an optical fiber lens 110. The optical fiber lens 110 includes a light diffusion region 102, a reflector surface 103 that is cut at a predetermined angle, and a lens surface 104.

The photonic crystal fiber 101 is also called a holey fiber or a micro-structured fiber. In the photonic crystal fiberol, a plurality of air holes (for example, 2 to 1000 air holes) are regularly or irregularly formed along a cladding 101a of an optical fiber. Here, the photonic crystal fiber 101 may be an optical fiber where a core of the optical fiber is not provided with air holes, or an optical fiber where air holes are formed in the core of the optical fiber but have different sizes from sizes of peripheral air holes.

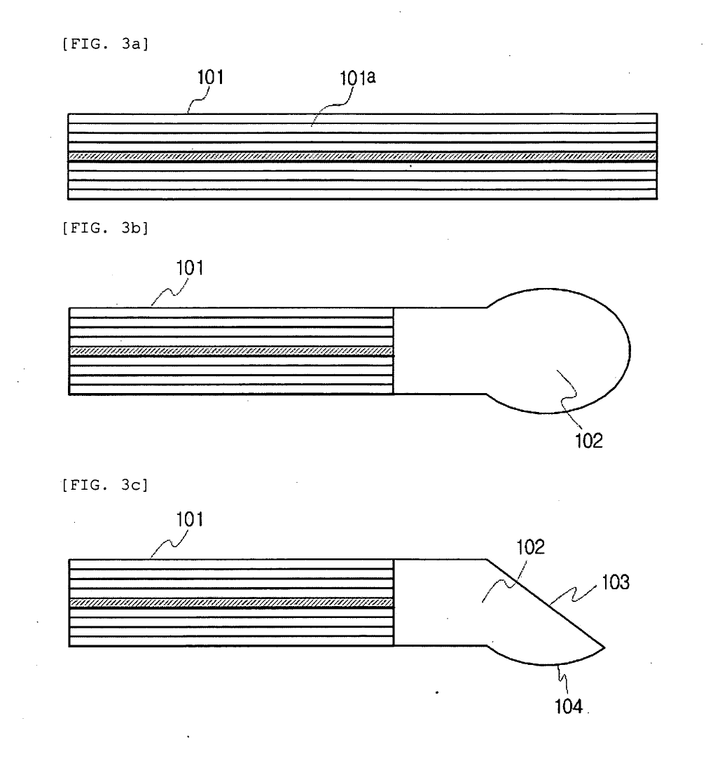

The light diffusion region 102 is extended to have a predetermined size when light guided along a core 101b of the optical fiber 101 reaches the optical fiber lens 110. The light diffusion region 102 may be formed using a method of removing air holes 101c (refer to FIG. 2) that are formed in the photonic crystal fiber 101.

The reflector surface 103 may be cut to have an angle at which total reflection of light is possible. Specifically, the reflector surface 103 may be cut at an angle of 43 degrees or more. For example, the reflector surface 103 may be cut at an angle of approximately 45 degrees.

The reflector surface 103 reflects light, which propagates along the light diffusion region 102, at approximately a right angle toward sides thereof, such that side imaging is possible.

The reflector surface 103 may be formed by micromachining using a laser, or a process including mechanical polishing, cutting or chemical etching.

The lens surface 104 focuses the light reflected on the reflector surface 103. In the case of the lens-typed optical fiber probe 100 shown in FIG. 1, the light diffusion region 102 and the lens surface 104 may be simultaneously formed by using a method of applying high-temperature heat using a laser without being bonded to different kinds of optical fibers or external elements.

Hereinafter, the operation principle of the lens-typed optical fiber probe 100 for side imaging shown in FIG. 1 is described. Light that is produced from an external light source unit is incident on the photonic crystal fiber 101 and propagates to the core 101b of the photonic crystal fiber 101. Then, while the light gradually diffuses in the light diffusion region 102, the light is reflected on the reflector surface 103 at a predetermined reflection angle toward the lens surface 104. The light that has been reflected on the reflector surface 103 diffuses until the light reaches the lens surface 104. While the light passes through the lens surface 104, the light is gradually focused.

Since the lens-typed optical fiber probe according to the embodiment of the invention uses, as the optical fiber, the photonic crystal fiber 101 that enables a single mode operation in a wide wavelength region, it becomes possible to freely select a light source. Therefore, the lens-typed optical fiber probe can be effectively used for an imaging system using light or a medical treatment apparatus using a laser, which has been actively studied in recent years. When using a broadband light source, it is possible to implement a high-resolution optical tomographic imaging system.

FIG. 2 is a cross-sectional view illustrating a photonic crystal fiber shown in FIG. 1. As shown in FIG. 2, the photonic crystal fiber 101 has a plurality of air holes 101c that are formed around the core 101b, different from a single mode optical fiber.

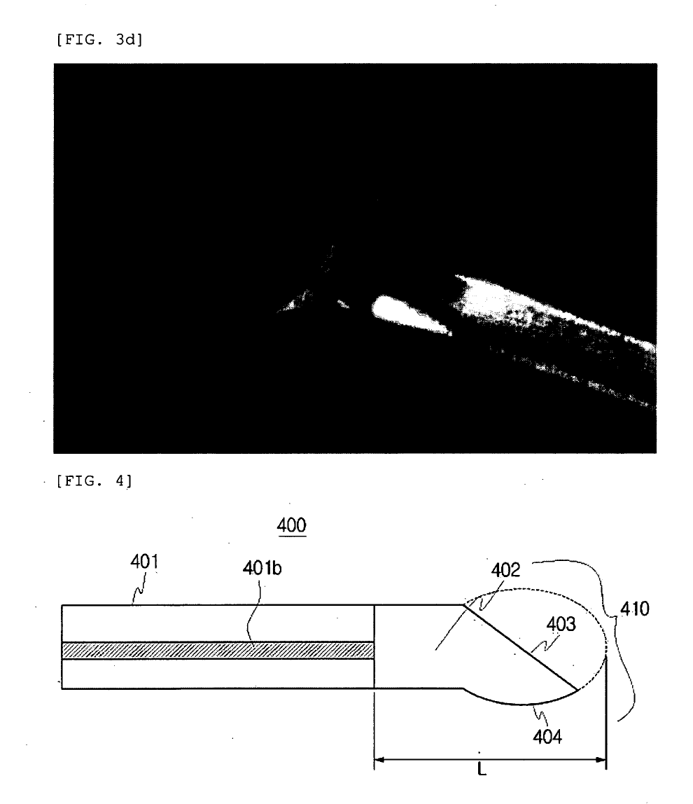

FIGS. 3A to 3C are cross-sectional views illustrating a process of manufacturing a lens-typed optical fiber probe 100 for side imaging shown in FIG. 1. Specifically, FIG. 3A is a cross-sectional view illustrating a photonic crystal fiber, FIG. 3B is a cross-sectional view illustrating a lens-typed photonic crystal fiber that has a light diffusion region and a ball lens integrally formed at one end of a photonic crystal fiber, and FIG. 3C is a cross-sectional view illustrating an optical fiber probe based on a photonic crystal fiber that is formed by cutting a ball-lens-typed photonic crystal fiber shown in FIG. 3B at a predetermined angle to enable side imaging.

First, a first process is performed, such that arc discharge, an oxygen-hydrogen flame, or a CO₂ laser is used to apply heat to one end of the photonic crystal fiber 101 shown in FIG. 3A.

As a result of the first process, since the air holes 101c existing in the cladding 101a of a portion, to which heat is applied using the arc discharge, the oxygen-hydrogen flame, or the CO₂ laser, are clogged, the light diffusion region 102 is naturally formed.

At this time, if increasing the temperature of heat that is applied to the photonic crystal fiber 101, one end of the photonic crystal fiber 101 is deformed in a form of a ball as shown in FIG. 3B, thereby forming a ball lens that functions as a lens. That is, if the heat is applied to the photonic crystal fiber 101, it is possible to simultaneously form the light diffusion region 102 and the ball lens that are required to construct an optical fiber lens without requiring an additional process. In this case, the size of the ball can be controlled by controlling the intensity and strength of arc discharge.

As an arc discharge system that is used to manufacture the optical fiber lens of the optical fiber probe according to the embodiment of the invention, an S183PM model manufactured by JDS FITEL Inc. is used, arc discharge power is 120 units in the specification of the S183PM model, and an arc discharge duration time is 1200 ms.

Next, a second process is performed such that the reflector surface 103 is processed in the ball lens that is formed for side imaging. The reflector surface 103 that is necessary for side imaging is formed by mechanically cutting a portion of the ball lens formed at one end of the photonic crystal fiber 101 at a predetermined angle, polishing the portion, processing the portion using a laser, or performing chemical etching on the portion. At the time of processing using a laser, for example, a femtosecond laser may be used.

If the second process is performed, it is possible to form on the ball lens the reflector surface 103 that enables side imaging, as shown in FIG. 3C. If controlling a formation angle of the reflector surface 103, it is possible to control a focal location of the optical fiber lens. Since the focal length of the optical fiber lens is determined depending on the length of the light diffusion region 102 of the coreless optical fiber and the radius of curvature of the ball lens, the focal length can be controlled.

The lens surface 104, which is located opposite to a processed surface that originally maintains a form of a ball, functions as a lens for light reflected on the reflector surface 103 toward sides thereof, that is, a condenser. A highly reflective coating process may be performed on the reflector surface 103 in order to improve reflection efficiency of the reflector surface.

FIG. 3D is a diagram illustrating a photomicrographic image for a lens-typed optical fiber probe for side imaging that is manufactured using a femtosecond laser in accordance with the preferred embodiment of the invention.

In FIG. 3D, at the time of laser processing that uses a femtosecond laser, the femtosecond laser has a wavelength of 785 nm, output of 1 Watt, a pulse width of 184 fs, the pulse intensity of 6.37 uJ, and a pulse repetition rate of 1 KHz.

During the process of manufacturing an optical fiber probe shown in FIG. 3D, a photonic crystal fiber that has an outer diameter of 0.125 mm is used as the optical fiber, a diameter of a formed ball lens is approximately 0.266 mm, and an angle of the reflector surface is approximately 45 degrees.

The optical fiber probe for side imaging according to the embodiment of the invention shown in FIG. 1 uses a characteristic of the photonic crystal fiber. However, in the optical fiber probe, the ball lens can be formed by only a process of applying heat to one end of the photonic crystal fiber without a bonding process between the photonic crystal fiber and a different kind of optical fiber. Therefore, the manufacturing process is simple and the optical fiber probe can be easily manufactured, as compared with the method of manufacturing an optical fiber probe according to the related art.

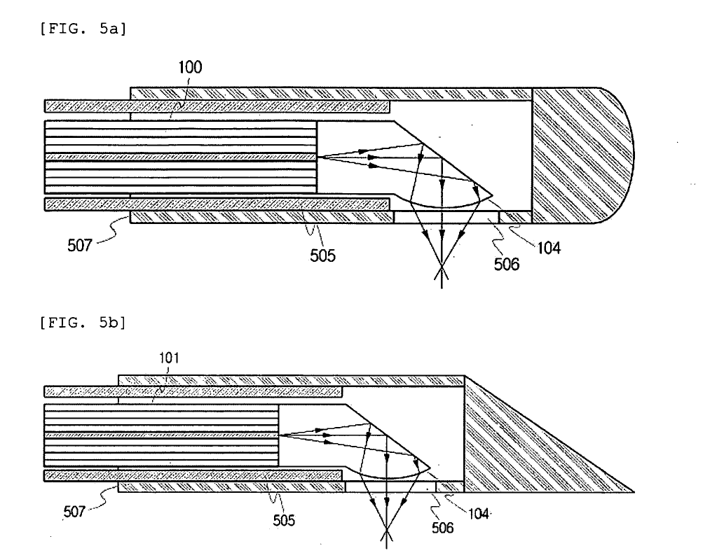

FIG. 4 is a cross-sectional view illustrating an optical fiber probe for side imaging according to another embodiment of the invention.

Referring to FIG. 4, an optical fiber probe 400 includes an optical fiber 401 and an optical fiber lens 410. The optical fiber 401 may be a single mode optical fiber having a core 401b or a photonic crystal fiber. The optical fiber lens 410 includes a light diffusion region 402, a reflector surface 403 that is cut at a predetermined angle, and a lens surface 404.

In the optical fiber probe 400, in order to form the light diffusion region 402 in the optical fiber 401, a coreless optical fiber lens having a predetermined length L, a silica rod lens, or a graded index (GRIN) lens is bonded to the optical fiber, high-temperature heat is applied to one end of the coreless optical fiber to deform one end to have a shape of the ball, and the lens surface 404 functioning as a lens is formed. The reflector surface 403 is formed through microprocessing using a laser. Here, heterojunction is made between the single mode optical fiber having a core (or a photonic crystal fiber having a core) and the coreless optical fiber. In this case, arc discharge, an oxygen-hydrogen flame, or a CO₂ laser is used to apply heat to one end of the coreless optical fiber, thereby forming the ball lens described above. The predetermined length L of the optical fiber lens that is attached to the optical fiber 401 may be the distance between a portion where heterojunction is made and an end of the ball lens, for example, the distance in a range of 0.05 to 3 mm.

In the optical fiber lens that is formed in accordance with the embodiments of the invention, arc discharge, an oxygen-hydrogen flame, or a CO₂ laser is used to apply heat to one end of the optical fiber, thereby forming the ball lens, as described with reference to FIGS. 3A, 3B, and 4. The size of the optical fiber lens can be controlled, and the optical fiber lens can be formed to have a small size. However, according to the method according to the related art that connects a commercially available ball lens having a predetermined size to a single mode optical fiber, the size of the commercially available ball lens is fixed, and larger than the size of the optical fiber lens that is formed in accordance with the embodiments of the invention. That is, if manufacturing the optical fiber lens using the manufacturing method according to the embodiments of the invention, it is possible to miniaturize the optical fiber lens, as compared with the case of using the method according to the related art that connects the commercially available ball lens having the predetermined size to the single mode optical fiber.

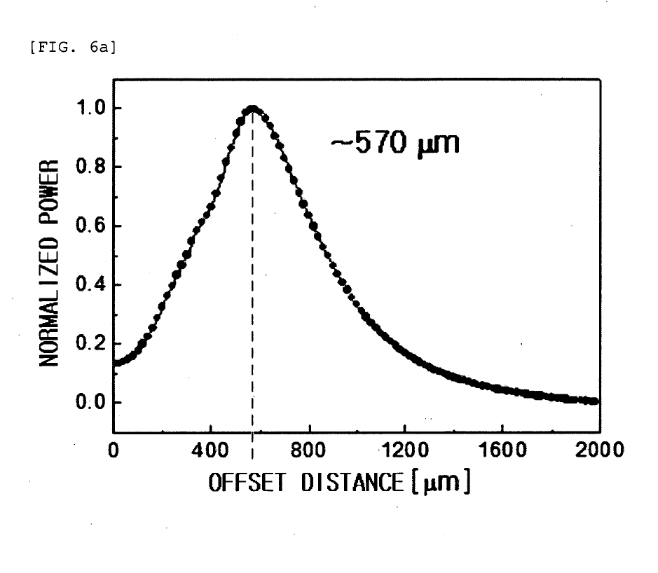

FIG. 5A is a diagram illustrating an optical fiber probe package that is formed by packaging an optical fiber probe manufactured in accordance with an embodiment of the invention so as to be used for an optical imaging system.

As shown in FIGS. 5A and 5B, an optical fiber probe package includes a primary packaging unit 505 and a secondary packaging unit 507 to protect the lens surface 104 of the optical fiber probe 100.

Specifically, referring to FIG. 5A, the optical fiber probe package includes the primary packaging unit 505 that covers the optical fiber probe except for the ball lens, the secondary packaging unit 507 that covers the primary packaging unit 505 and the ball lens of the optical fiber probe, and a beam emission hole 506 that is used to output light emitted from the lens surface 104 of the optical fiber probe 100 to the outside.

FIG. 5B is a diagram illustrating an optical fiber probe package that is formed by packaging an optical fiber probe manufactured in accordance with another embodiment of the invention so as to be used for an optical imaging system. FIG. 5B shows a needle-typed optical fiber probe. The optical fiber probe package shown in FIG. 5B is the same as the optical fiber probe package shown in FIG. 5A except that one end of the optical fiber probe package has a needle shape.

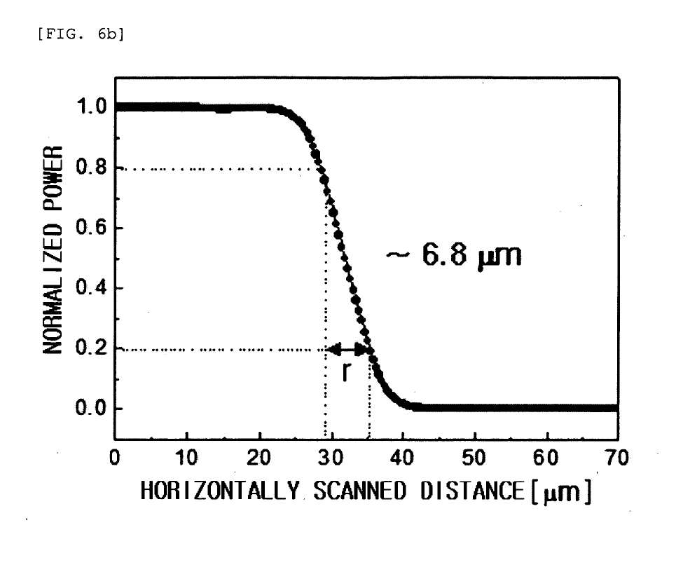

FIG. 6A is a graph illustrating a measured result of a lens characteristic of a lens-typed optical fiber probe according to an embodiment of the invention. Specifically, FIG. 6A shows a measured result of a change in light power in response to an offset distance between the lens surface 104 of the optical fiber probe 100 and a reflection mirror.

In FIG. 6A, in order to calculate a working distance of a lens of the optical fiber probe based on the lens-typed photonic crystal fiber that is manufactured using the processes shown in FIGS. 3A to 3C, in a state where the refection mirror is located at the lens surface 104 of the optical fiber probe 100 (distance=0), power of light, which is reflected on the reflection mirror and recombined in the optical fiber probe 100, is observed while an offset distance between the lens surface 104 and the reflection mirror is increased, and the observed result is shown. The working distance of the lens is defined as a location where the light power is maximized.

As described above, when the location where the light power is maximized is defined as the working distance, it can be seen that the working distance of the optical fiber lens is approximately 570 μm, as shown in FIG. 6A.

FIG. 6B is a graph illustrating a measured result of sizes of beams that are focused at a focal location of a lens of a lens-typed optical fiber probe according to an embodiment of the invention.

In FIG. 6B, while a reflector having a vertically cut edge is scanned in a horizontal direction after the reflector is moved by the working distance of approximately 570 μm that corresponds to the focal location of the lens calculated with reference to FIG. 6A, power of light, which is reflected on the reflector and then recombined in the optical fiber probe, is measured, and the measured result is shown.

Referring to FIG. 6B, it can be seen that 6.8 μm is a diameter r of a beam focused at a horizontally scanned distance needed when light power changes in a range of 20 to 80% on the basis of a maximal combined numerical value.

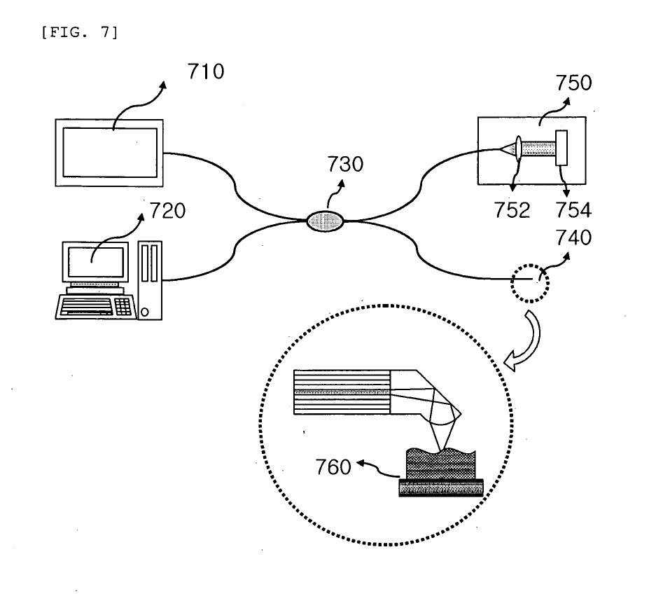

FIG. 7 is a conceptual diagram illustrating a light measurement system that is used to obtain side image information for a sample using an optical fiber probe for side imaging based on a lens-typed photonic crystal fiber according to an embodiment of the invention.

Referring to FIG. 7, a light measurement system includes a light source unit 710, a signal processing unit 720, an optical fiber beam splitter 730, and a sensing unit 740. In this case, the sensing unit 740 includes the above-described optical fiber probe 100 and a sample 760 that becomes a light measurement target.

A process of measuring side images for the sample 760 will now be described with reference to FIG. 7.

First, light produced from the light source unit 710 is incident on the optical fiber probe 100 through the optical fiber beam splitter 730. The light, which is emitted to the sides of the optical fiber probe 100 and focused in the sample 760 to be measured, is reflected by the sample 760. After that, in reverse order, the light passes through the optical fiber probe 100 and is then input to the signal processing unit 720 as an optical signal via the optical fiber beam splitter 730. The optical signal is detected by the signal processing unit 720.

The signal processing unit 720 analyzes the detected signal and generates a final image of the sample 760 in a depth-wise direction by a predetermined computation process and an image signal process. At this time, a physical quantity that is measured by the signal processing unit 720 may be only the intensity of the light reflected on the sample 760, and a fluorescent or a Raman signal.

Further, if a base end 750 is additionally provided in the light measurement system, it is possible to extract two-dimensional image information on the sample 760 from an interference image using an optical path difference between the base end 750 and a sample end. In this case, the base end 750 includes a collimator 752 that collimates light and a transfer stage 754 to which a reference mirror is attached. The optical path difference between the base end 750 and the sample end can be controlled while the transfer stage 754 is moved to change the relative positions between the reference mirror and the collimator 752.

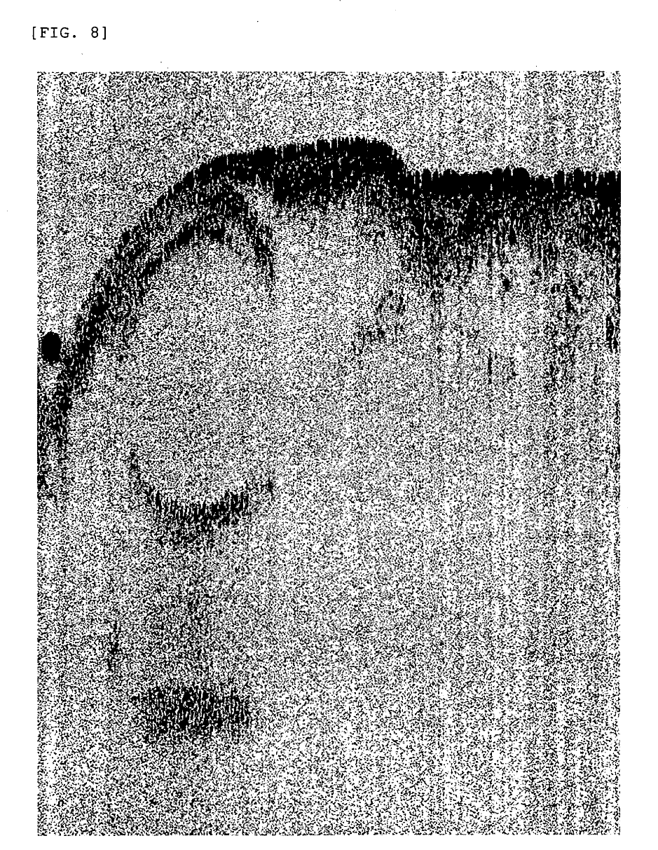

FIG. 8 is a diagram illustrating a two-dimensional optical tomographic image for eyes of a Zebra fish that is a kind of tropical fish that is actually measured using an optical fiber probe for side imaging based on a photonic crystal fiber according to an embodiment of the invention in an optical tomographic imaging system.

Although the present invention has been described in connection with the exemplary embodiments of the present invention, it will be apparent to those skilled in the art that various modifications and changes may be made thereto without departing from the scope and spirit of the invention. Therefore, it should be understood that the above embodiments are not limitative, but illustrative in all aspects. The scope of the present invention is defined by the appended claims rather than by the description preceding them, and all changes and modifications that fall within metes and bounds of the claims, or equivalents of such metes and bounds are therefore intended to be embraced by the claims.

What is claimed is:

1. An optical fiber probe comprising:
a photonic crystal fiber; and
an optical fiber lens that is formed by applying heat to a predetermined region including one end of the photonic crystal fiber and substantially removing air holes formed in the predetermined region, and diffuses light propagating along a core of the photonic crystal fiber and focuses the light to enable side imaging.

2. The optical fiber probe of claim 1,
wherein the optical fiber lens includes:
a light diffusion region that is formed by applying the heat to the predetermined region including one end of the photonic crystal fiber and substantially removing the air holes formed in the predetermined region;
a reflector surface that is formed by, at a predetermined angle, cutting a first region of a ball lens formed at one end of the photonic crystal fiber together with the light diffusion region during the heat application process so as to enable full reflection; and
a lens surface that is formed in a second region of the ball lens and focuses the light reflected on the reflector surface.

3. The optical fiber probe of claim 2,
wherein heat is applied to the predetermined region including one end of the photonic crystal fiber using one of arc discharge, a CO₂ laser, and an oxygen-hydrogen flame.

4. The optical fiber probe of claim 2,
wherein the reflector surface is formed by cutting the first region of the ball lens using one of mechanical cutting, polishing, chemical etching, and laser processing.

5. The optical fiber probe of claim 4,
wherein the laser processing is performed using a femtosecond laser.

6. The optical fiber probe of claim 4,
wherein the reflector surface is subjected to a highly reflective coating process so as to improve reflection efficiency.

7. A method of manufacturing an optical fiber probe, the method comprising:
providing a photonic crystal fiber;
applying heat to a predetermined region including one end of the photonic crystal fiber and substantially removing air holes formed in the predetermined region;
continuously applying heat to the predetermined region to form a ball lens having a predetermined size; and
forming a reflector surface and a lens surface functioning as a lens by cutting a first region of the ball lens at a predetermined angle to enable full reflection.

8. The method of claim 7,
wherein the lens surface is formed in a second region of the ball lens and focuses light reflected on the reflector surface.

9. The method of claim 7,
wherein the applying of heat to the predetermined region including one end of the photonic crystal fiber is applying heat to the predetermined region including one end of the photonic crystal fiber using one of arc discharge, a CO₂ laser, and an oxygen-hydrogen flame.

10. The method of claim 7,
wherein the forming of the reflector surface by cutting the first region of the ball lens at the predetermined angle is forming the reflector surface by cutting the first region of the ball lens at the predetermined angle using one of mechanical cutting, polishing, chemical etching, and laser processing.

11. The method of claim 10,
wherein the laser processing is performed using a femtosecond laser.

12. An optical fiber probe comprising:
a first optical fiber including a core; and
an optical fiber lens that is formed by performing heterojunction between one end of a second optical fiber and one end of the first optical fiber and applying heat to the other end of the second optical fiber to form a ball lens, and diffuses light propagating along a core of the first optical fiber to have a predetermined amount of light and focuses the light to enable side imaging.

13. The optical fiber probe of claim 12,
wherein the optical fiber lens includes:
a light diffusion region that diffuses the light propagating along the core of the first optical fiber;
a reflector surface that is formed by cutting, at a predetermined angle, the first region of the ball lens formed by applying heat to the other end of the second optical fiber so as to enable full reflection; and
a lens surface that is formed in a second region of the ball lens and focuses light reflected on the reflector surface.

14. A method of manufacturing an optical fiber probe, the method comprising:
providing a first optical fiber including a core;
performing heterojunction between one end of a second optical fiber and one end of the first optical fiber and applying heat to a predetermined region including the other end of the second optical fiber so as to form a ball lens; and
forming a reflector surface and a lens surface functioning as a lens by cutting a first region of the ball lens at a predetermined angle to enable full reflection.

15. The method of claim 14,
wherein the second optical fiber is a coreless optical fiber or a graded index (GRIN) lens.
